(19) United States
(12) Patent Application Publication
(10) Pub. No.: US 2023/0072435 A1
(43) Pub. Date: Mar. 9, 2023

(54) Display Device, Vehicle, and Method for Operating a Display Device

(71) Applicant: Bayerische Motoren Werke Aktiengesellschaft, Muenchen (DE)

(72) Inventor: Harald LATHWESEN, Mauern (DE)

(21) Appl. No.: 17/794,716

(22) PCT Filed: Dec. 17, 2020
(86) PCT No.: PCT/EP2020/086873

§ 371 Date: Jul. 22, 2022

(30) Foreign Application Priority Data
Jan. 24, 2020 (DE) 10 2020 101 719.7

(51) Int. Cl. B60R 11/02

(52) U.S. Cl. CPC B60R 11/0235; B60R 2011/0028

(57) ABSTRACT

A display device for the interior of a vehicle, includes: (i) a display unit which is designed to optically display information and which is arranged or can be arranged on a roofliner of the vehicle, and (ii) a movement unit which is designed to move the display unit between different use settings along the direction of longitudinal extension of the vehicle in a controllable and/or regulatable manner and/or to hold the display unit in a specified use setting. A first use setting has a first position for or in a front seat row, when viewed in the direction of longitudinal extension, and a second use setting has a second position for or in a rear seat row, when viewed in the direction of longitudinal extension, or for or in a luggage space for the display unit.

### BACKGROUND AND SUMMARY

The present invention relates to a display device for the interior of a vehicle, a vehicle as such, and a method for operating a display device.

Installing a display device for optically displaying information associated with a seat on the inside of the vehicle roof, for example, on the roofliner, in a vehicle and in particular in a motor vehicle or passenger vehicle in general, is known.

Such known display devices are associated in the usage state with an observer in a predetermined rear seat row and attached accordingly there. Adjustment mechanisms are sometimes proposed for adjusting a viewing distance, but they do not permit sufficiently flexible handling in consideration of other interior components of the vehicle. The installation space available overall for the arrangement of the display device is also often only used inadequately.

The invention is based on the object of providing a display device for the interior of a vehicle, a vehicle as such, and a method for operating a display device, in which using simple means, a reliable and flexible handling of a display unit installed on a roofliner is possible in consideration of a plurality of seat rows spaced apart from one another.

The object of the invention is achieved by a display device, by a vehicle, and by a method for operating the display device, according to the features of the independent claims. Advantageous refinements are the respective subject matter of the dependent claims.

According to a first aspect of the present invention, a display device for the interior of a vehicle, and in particular a motor vehicle or passenger vehicle, is provided, which is formed:
(i) having a display unit, which is configured for the visual display of information and is arrangeable or arranged on a roofliner of the vehicle, and
(ii) having a movement unit, which is configured to move the display unit along a longitudinal extension direction X of the vehicle controllably in an open-loop and/or closed-loop manner between various usage settings and/or to hold it in a given usage setting,
(iii) wherein a first usage setting has a first position for or in a front seat row in the longitudinal extension direction X and a second usage setting has a second position for or in a rear seat row in the longitudinal extension direction X or for or in a baggage compartment for the display unit.

Using the measures taken according to the invention, handling a display unit installed on a roofliner is possible in a reliable and flexible manner without significant additional effort, in particular in that an underlying display or display unit is movable between usage settings for various seat rows and can be positioned and held there.

In principle, all mechanical elements are usable in combination with one another which enable moving, positioning, and/or holding the display unit at the various positions and/or settings associated with the various seat rows and/or the baggage compartment.

According to one preferred embodiment of the display device according to the invention, particularly simple relationships result if the movement unit is formed:
(a) attached using guide elements on the display unit for defining a pivot axis for pivoting the display unit at least between a usage setting and a non-usage setting, parallel to the roofliner, and/or
(b) having guide rails to be attached on the roofliner, having a guide path for accommodating the guide elements and moving them therein along the guide path.

The movement unit is additionally or alternatively thereto configured to transfer the display unit, in particular controllably in a closed-loop manner, between a or the non-usage setting, in particular in parallel to a roofliner of the vehicle, and a usage setting, in particular pivoted away from the roofliner of the vehicle, and vice versa, and to hold it, in particular controllably in a closed-loop manner, in the non-usage setting and/or a usage setting.

Furthermore, the guide rails and the guide paths can additionally or alternatively extend in the longitudinal extension direction X at least between the positions to the usage settings or beyond them.

A front seat row in the longitudinal extension direction X can be a first or frontmost seat row for driver and front passenger or a second seat row behind driver and front passenger.

A rear seat row in the longitudinal extension direction X can be a second seat row behind driver and passenger or a third or rearmost seat row behind a second seat row.

A corresponding control unit can be designed to control in an open-loop and/or closed-loop manner the movement and/or the selection and the assumption of the respective position, setting, orientation, and/or alignment of the display unit.

In one advantageous exemplary embodiment of the display device according to the invention, a designed control unit is configured to control in a closed-loop and/or open-loop manner the movement unit in such a way that the display unit and/or a display element thereof:
(i) is or remains folded back before and/or for a movement between usage settings and/or positions from an existing position pivoted away from the roofliner into a or the non-usage setting and/or toward a or the non-usage setting in the direction toward the roofliner, and/or
(ii) is only moved out of a region behind a seat row, in particular out of a position of a rear usage setting in the longitudinal extension direction X into a region in front of it, in particular into a position of a front usage setting in the longitudinal extension direction X, when a seat or the seats of the seat row is or are located in a collision-avoiding setting, position, orientation, and/or in a relaxed setting, preferably in a setting with a backrest of the seat row folded back.

Particularly reliable and secure operation of the display device according to the invention results using these measures.

In principle, all measures are usable which are capable of checking distances, positions, orientations, and/or alignments to be maintained of interior components, in particular of seat rows and seats, which are relevant for smooth movement and positioning of the display unit. This can take place, on the one hand, by explicit measurement processes and alternatively or additionally by the acquisition of control data, which are used for adjusting the seat rows and their elements.

One particularly preferred refinement of the display device according to the invention is thus formed having a sensor unit or a first operational connection to a sensor unit, wherein the sensor unit is configured to acquire a current position and/or alignment of a respective seat row, one part or multiple parts thereof, and/or an occupant – in particular in relation to the display unit and/or to a display element - and to transmit a signal representative thereof to the control unit, in particular to control in a closed-loop manner, via a or the control unit, the movement unit and as a result a position, orientation, and/or usage setting of the display unit and/or a display element thereof as a function of the representative signal.

Alternatively or additionally, the display device according to the invention can be formed having a second operational connection to a control unit of a seat row and can be configured to control in a closed-loop manner the movement unit and, as a result, a position, orientation, and/or usage setting of the display unit and/or a display element thereof as a function of control data of the control unit for adjusting a seat row.

On the basis of the signal, which is representative of one or more distances, positions, orientations, and/or alignments of one or more seat rows and/or their components –in particular mediated by the control unit - the movement unit can be controlled in an open-loop or closed-loop manner to achieve or ensure a corresponding movement and/or tracking of the display unit and/or the display element, possibly with required maintenance of distances or distance intervals.

In principle, the concept according to the invention can be used with all display devices which occupy a certain operating and structural space during operation in the interior of the vehicle.

However, the present invention reveals itself to be particularly advantageous in those cases in which the display unit is formed having essentially rectangular shape, in the state of the display device installed on the associated vehicle having transverse edges aligned parallel to a transverse extension direction of the vehicle and/or in the state of the display device installed on the associated vehicle having longitudinal edges aligned in parallel to a longitudinal extension direction of the associated vehicle.

For smooth operation, in particular with regard to fully automatic transfer of the display unit and/or the display element between the usage settings and the non-usage setting, in another embodiment of the display device according to the invention, a drive unit is formed which is configured to drive the movement unit and/or which can be controlled in an open-loop and/or closed-loop manner in its operation via a or the control unit.

According to another aspect of the present invention, a vehicle is also provided which has a vehicle body, an interior formed by the vehicle body having a roofliner, and a display device attached on or in the roofliner and designed according to the invention.

According to another alternative or additional aspect of the present invention, an operating method for a display device for the interior of a vehicle is also provided, wherein:
(a) the display device is formed having a display unit for the visual display of information, which is arrangeable or arranged on a roofliner of the vehicle,
(b) the display unit, in particular via a movement unit, is moved along the longitudinal extension direction controllably in an open-loop and/or closed-loop manner between various usage settings and/or is held in a given usage setting, and
(c) a movement of the display unit is controlled in an open-loop and/or closed-loop manner, in particular by means of a control unit, in such a way that a first usage setting has a first position for the display unit for a or in a front seat row in the longitudinal extension direction and a second usage setting has a second position for a or in a rear seat row in the longitudinal extension direction or for a or in a baggage compartment.

Further details, features, and advantages of the invention result from the following description and the figure.

### BRIEF DESCRIPTION OF THE DRAWINGS

FIGS. 1 and 2 are schematic and perspective side views of an embodiment of the vehicle according to the invention which is equipped with an embodiment of the display device according to the invention, wherein the display unit is arranged in various settings in the interior of the vehicle;

FIGS. 3 and 4 are schematic side views in partial section of various constellations of the display device in conjunction with a vehicle.

### DETAILED DESCRIPTION OF THE DRAWINGS

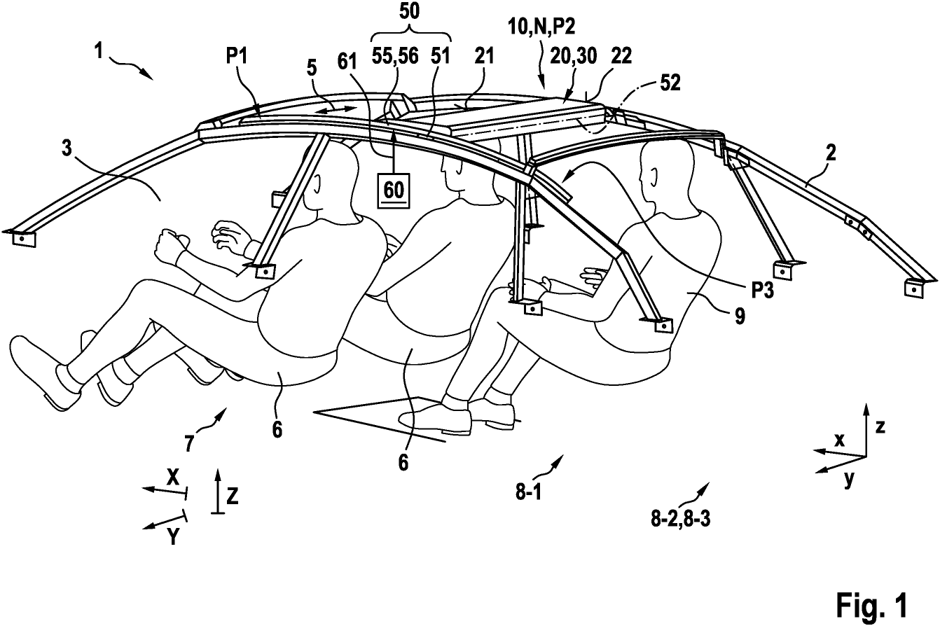

Exemplary embodiments and the technical background of the invention are described in detail hereinafter with reference to FIGS. 1 to 4. Identical and equivalent and identically or equivalently acting elements and components are identified by the same reference numerals. The detailed description of the identified elements and components is not reproduced every time they appear.

The illustrated features and further properties can be isolated from one another and combined with one another in any form without departing from the core concept of the invention.

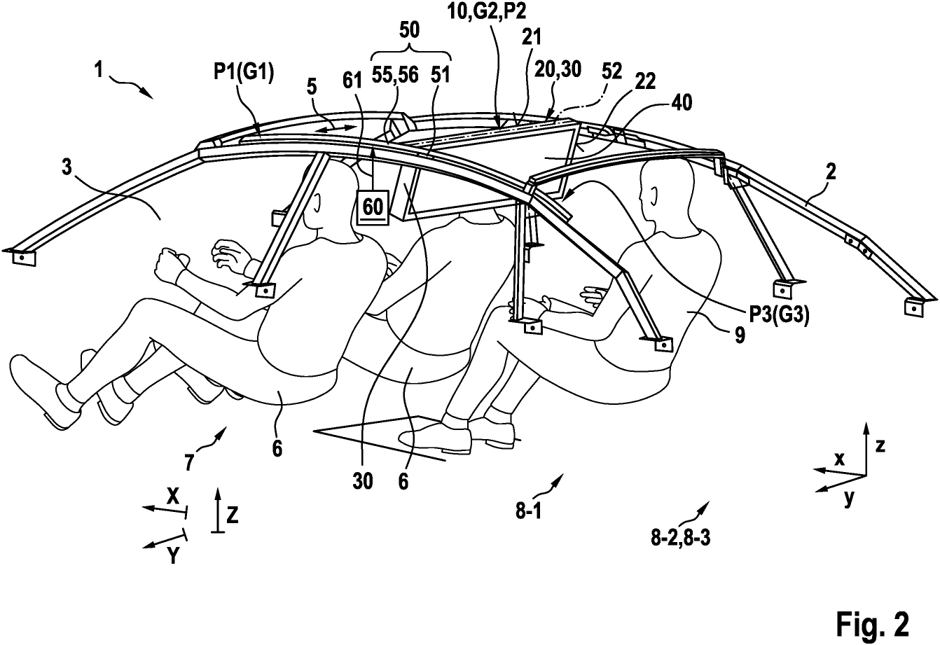

FIGS. 1 and 2 show a schematic and perspective side view of an embodiment of the vehicle 1 which is equipped with an embodiment of the display device 10, wherein the display unit 20 of the display device 10 is arrangeable in various settings N, G1, G2, G3 at corresponding positions P1, P1', P2, P3 in the interior 3 of the vehicle 1.

In all figures and also in FIGS. 1 and 2, the vehicle 1 is schematically shown by components of a vehicle body 2, which form and enclose an interior 3 of the vehicle 1 and define a roofliner 5.

The respective vehicle 1 extends in a longitudinal extension direction X in parallel to the x direction, in a transverse extension direction Y in parallel to the y direction, and in a vertical direction Z in parallel to the z direction, which are defined by the respective indicated coordinate system.

A respective illustrated display device 10 is formed in the illustrations of FIGS. 1 and 2 by the actual display unit 20, for example, having a carrier 30, which carries a display element 40, for example, a monitor or a display screen, as shown in FIG. 2.

The display unit 20 is essentially rectangular in form here having longer transverse edges 21 in parallel to the transverse extension direction Y of the vehicle 1 and having shorter longitudinal edges 22 in parallel to the longitudinal extension direction X of the vehicle 1.

Furthermore, a movement unit 50 is part of the display device 10. This is formed in the embodiment shown in FIGS. 1 and 2, inter alia, by two guide rails 55, which define guide paths 56 and in which guide elements 51 run.

The guide rails 55 are formed identically in this embodiment, have a linear form having equal length, are arranged in parallel to one another and flush with the roofliner 5, and each form one of the guide paths 56. In principle, curved guide rails 55 are also contemplated. The guide rails 55 extend in the embodiment of FIGS. 1 and 2 in the longitudinal extension direction X of the vehicle 1. They are located spaced apart from one another in the transverse extension direction Y on the sides of the roofliner 5, thus in particular in the transition from the roof to the vehicle side.

The guide elements 51 are formed, for example, as sliders and are configured to be accommodated in a respective guide rail 55 and moved therein or to move along the respective guide path 56.

In the region of a first transverse edge 21 of the display unit 20, the guide elements 51 are attached rotatably mounted on the display unit 20 in such a way that a pivot axis or axis of rotation 52 of the display unit 20 is thus defined. The installation takes place in particular on that transverse edge 21 of the display unit 20 which is located on a side which is associated with the back of a vehicle 1 and which upon installation of the display unit 20 on the vehicle 1 faces toward the side of the back of the vehicle 1. The installation of first guide elements 51 preferably takes place in the neighborhood of the opposing longitudinal edges 22 of the display unit 20, thus in particular more or less in the intersection region of the longitudinal edges 22 and the transverse edges 21.

Using the arrangement made up of first and second guide elements 51 and possibly coupling levers and the guide rails 55 having guide paths 56, the possibility results when moving the guide elements 51 in the guide rails 55 of changing between a non-usage setting N and one or more usage settings G1, G2, G3 of the display unit 20, wherein various angles of inclination in relation to the roofliner 5 and/or various lateral positions P1, P1', P2, P3 can be assumed along the guide rails 55 and thus during installation in a vehicle 1 along the longitudinal extension direction X of the vehicle 1.

The positions P1, P1', P2, P3, for the usage settings G1, G2, G3, are associated with the first or frontmost seat row 7, the second or rear seat row 8-1, or the third or rearmost seat row 8-2 or the baggage compartment 8-3 and are spatially arranged there.

In FIG. 1, the display unit 20 is in a non-usage setting N, namely in a state in which the display unit is aligned essentially parallel to the roofliner 5.

In the transition to an intermediate state, the display unit 50 is pivoted down from the roofliner 5 into the passenger compartment 3 by corresponding movement of the first and second guide elements 51 in the guide rail 55, in order to occupy a usage setting G2 for the second or rear seat row 8-1, behind the frontmost seat row for driver 6 and front passenger 6.

In the transition to the intermediate state shown in FIG. 2, the display unit 20 is pivoted out to form a larger angle in relation to the roofliner 5 and transferred into a further usage setting G2, which is perpendicularly aligned more strongly, for the second, rear seat row 8-1.

In the transition to other states – for example, the usage setting G1 for the first seat row 7 for driver 6 and front passenger 6 or for the third or rearmost seat row 8-2 or for the baggage compartment 8-3 - by simultaneous movement of the first and second guide elements 51 and in particular by movement at equal speed and equal distance, a displacement with prior partial or complete folding up can then be effectuated.

In principle, in the embodiments of FIGS. 1 and 2, the control unit 60 required in some embodiments of the invention for controlling the movement unit 50 in a closed-loop manner is shown solely schematically with corresponding operational connections, for example, an acquisition and/or control line 61.

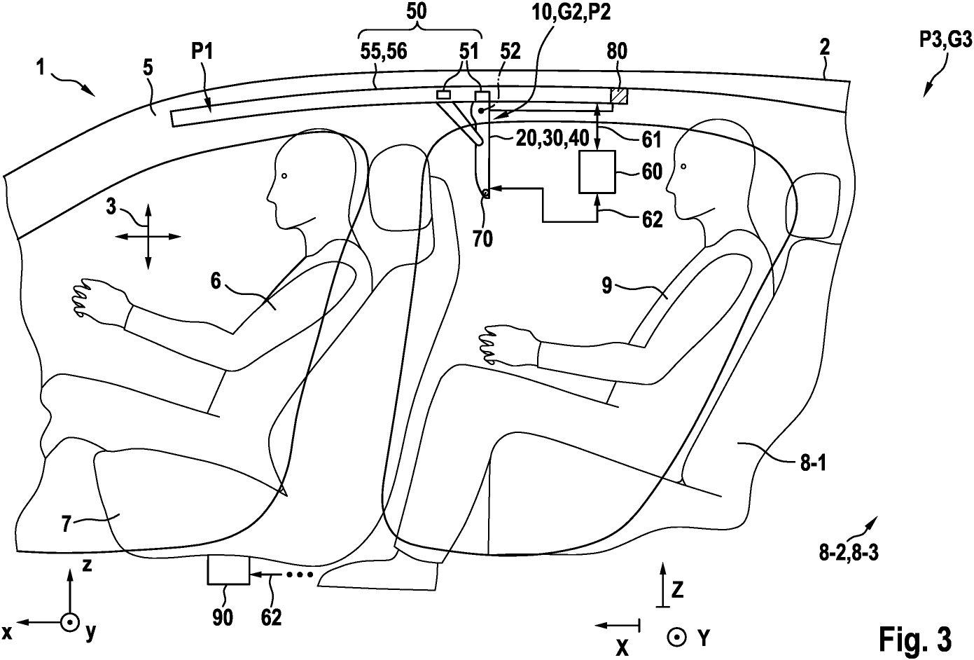

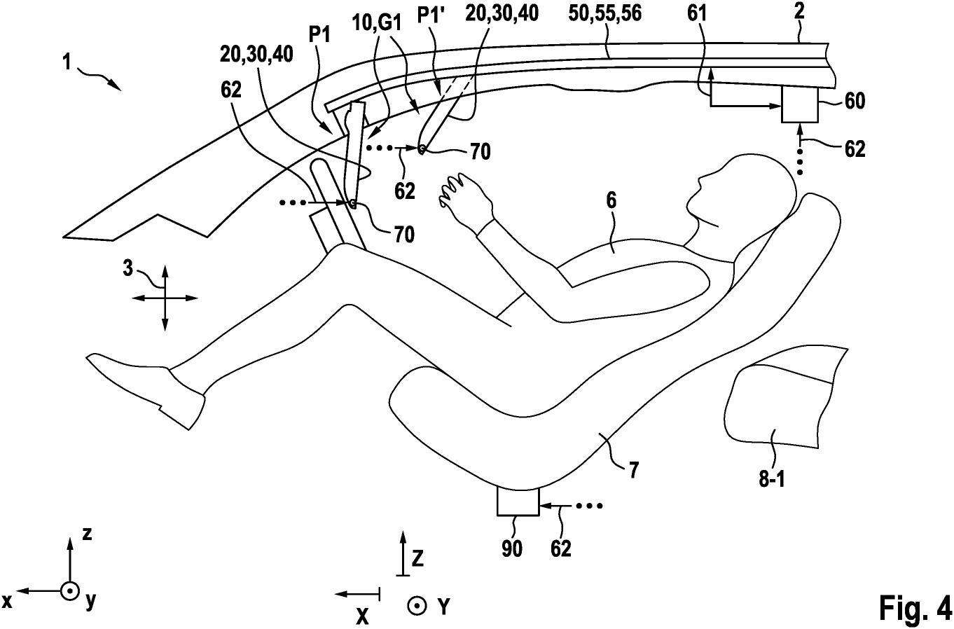

Details in this regard result in conjunction with the embodiments of the display device 10 shown in FIGS. 3 and 4 and the vehicles 1 equipped with the display device.

For this purpose, FIGS. 3 and 4 show various positions of the display device 10 in a schematic side view in partial section in conjunction with a respective vehicle 1.

In FIGS. 3 and 4, various scenarios are shown in which the display device 10 is or will have the respective display unit 20 having the display element 40 positioned on the carrier 30 in the interior 3 and on the roofliner 5 of the vehicle 1 in dependence on the operating conditions.

The display unit 20 can assume a non-usage setting N parallel to the roofliner 5, namely via the operation of the movement unit 50 and in particular the control of the drive 80 in a closed-loop manner using the control unit 60 with use of a first acquisition and/or control line 61 as the operational connection.

Furthermore, in the illustrations of FIGS. 3 and 4, second operational connections are provided, namely in the form of second acquisition and/or control lines 62, between the control unit 60 and a sensor unit 70 or alternatively or additionally a control unit 90 for the front seat row 7 and the corresponding elements, for example a head rest.

The sensor unit 70 can be used to detect a distance between the display unit 20 and the front seat row 7 or the element thereof or a setting, orientation, and/or position of the front seat row 7.

Additionally or alternatively, the sensor unit 70 can also be designed to ascertain a distance from the display unit 20 to an occupant 6 in the front seat row 7 and/or to a person 9 seated at the rear. In this way, it is possible to establish whether the necessity or possibility of moving the display unit 10 along the guide path 56 exists, in particular without obstacle.

Using the measures of the present invention, the interior 3 of a vehicle 1, which is very limited, can be better utilized. The front seats 7 pass over a large proportion of the interior 3 via their adjustment field for adjustment to people of different sizes and their posture habits. With stationary installation of a display 20 or with a simple folding kinematic mechanism, the monitor 40 has to be arranged behind the maximum adjustment field. The display 20 is thus displaced far to the rear and therefore unnecessarily shortens the observation distance from the back of the vehicle for most people.

Seats 7 in the front row and also the display kinematic mechanism in the meaning of the movement unit 50 possibly have controllers 60 and/or 90, by which movements are controlled in a closed-loop manner accordingly.

Both controllers 60 and 90 can be made capable of calculating a characteristic point and/or a characteristic surface on the respective components via the adjustment, which is or are suitable for maintaining a distance of the two components in relation to one another.

The display 20 can thus be set on the roof or roofliner 5 in a given or desired usage setting G1, G2, G3 at corresponding positions P1, P1', P2, P3 and corresponding viewing distances.

Therefore, using the measures provided here, large display devices 10 can be used to entertain vehicle occupants, which were previously offered in the back of the vehicle, in arbitrary seat rows 7, 8-1, 8-2 in the vehicle 1, namely in that a designed display device 10 is moved and positioned between the various seat rows 7, 8-1, 8-2.

The controllable positioning ability in a closed-loop manner of the display device 10 and display unit 20 is important according to the invention, whereas conventional known displays 20 are installed in a stationary manner in the vehicle 1. In the back of the vehicle, the displays 20 are usually fastened on the front seats 7. Simple folding displays on the vehicle roofliner 5 are offered isolated, often as a retrofit solution.

In the future, there will also be vehicles 1 which drive fully automatically. An entertainment offering can therefore also be offered to the driver 6 via a display unit 20 or a display. In conjunction with the autonomous driver 6, recumbent seats are also being developed for the first seat row 7, which enable resting, relaxing, or also sleeping in the vehicle 1. If the front seat 7 is in this sleeping or relaxing position, the back seats 8-1, 8-2 often can no longer be used. A large display 20 in the back – for example having an 800 mm wide display - cannot be used in the rear in this seat situation, since no one can sit there.

The kinematic mechanism or movement unit 50 designed according to the invention having guide rail 55 and guide paths 56 makes it possible for designed display units 20 or display devices 10 having a folded-up display 20 to be moved forward from the back over the head of the driver 6 and/or front passenger 6 up to the windshield and folded down there. The display 20 can thus be used for entertainment in the back with a completely occupied vehicle 1 and in the front with only two recumbent people 6.

The positions P1 and P1' for the first usage setting G1 are to be understood as two possible alternative positions having different visibility range and/or having different inclination.

### LIST OF REFERENCE SIGNS

1 vehicle
2 body
3 interior
5 roofliner
6 passenger/occupant front, driver, front passenger
7 seat/seat row front, first/frontmost seat row (for driver/front passenger)
8-1 seat/seat row rear, second/rear/middle seat row (behind driver, front passenger)
8-2 seat/seat row rear, third/rearmost seat row
8-3 baggage compartment, luggage compartment, storage space, cargo space
9 passenger/occupant rear
10 display device
20 display unit, display
21 transverse edge
22 longitudinal edge
30 carrier
40 display element, monitor, display screen
50 movement unit
51 guide element
52 axis of rotation/pivot axis
55 guide rail
56 guide path
60 control unit
61 operational connection, (first) acquisition and/or control line
62 operational connection, (second) acquisition and/or control line
70 sensor unit
80 drive unit
90 control unit for the seat/the front seat row
G1 (first) usage setting, in particular for first seat row 7
G2 (second) usage setting, in particular for second seat row 8-1
G3 (third) usage setting, in particular for third seat row 8-2 or baggage compartment 8-3
N non-usage setting
P1 position for the usage setting G1 in the longitudinal extension direction X
P1' position for the usage setting G1 in the longitudinal extension direction X
P2 position for the usage setting G2 in the longitudinal extension direction X
P3 position for the usage setting G3 in the longitudinal extension direction X
x spatial direction
X longitudinal extension direction of the vehicle 1
y spatial direction
Y transverse extension direction of the vehicle 1
z spatial direction
Z vertical extension direction of the vehicle 1

1-10. (canceled)

11. A display device for an interior of a vehicle, comprising:
(i) a display unit, which is configured to optically display information and which is arrangeable on a roofliner of the vehicle; and
(ii) a movement unit, which is configured to move the display unit between different usage settings along a longitudinal extension direction of the vehicle controllably in an open-loop and/or closed-loop manner, and/or to hold the display unit in a given usage setting,
(iii) wherein a first usage setting has a first position for or in a front seat row in the longitudinal extension direction and a second usage setting has a second position for or in a rear seat row in the longitudinal extension direction or for or in a luggage compartment for the display unit.

12. The display device according to claim 11, wherein the movement unit:
(i) comprises guide elements attached to the display unit for defining a pivot axis for pivoting the display unit at least between a usage setting and a non-usage setting,
(ii) comprises guide rails attachable to the roofliner, and forming a guide path, wherein the guide rails accommodate the guide elements and guide their movement therein along the guide path, and/or
(iii) is configured to transfer the display unit, between a non-usage setting in parallel to the roofliner of the vehicle, and a usage setting pivoted down from the roofliner of the vehicle, and vice versa, and to hold the display unit in the non-usage setting and/or the usage setting,
(iv) wherein the guide rails and the guide paths extend in the longitudinal extension direction at least between the positions for the usage settings.

13. The display device according to claim 11, wherein
(i) a front seat row in the longitudinal extension direction is a first or frontmost seat row for a driver and front passenger or a second seat row behind the driver and front passenger, and/or
(ii) a rear seat row in the longitudinal extension direction is a second seat row behind the driver and front passenger or a third or rearmost seat row behind the second seat row.

14. The display device according to claim 11, further comprising:
a control unit, which is configured to control the movement unit in a closed-loop and/or open-loop manner such that the display unit and/or a display element thereof:
(i) before and/or for a movement between usage settings and/or positions, is or remains folded back from an existing position pivoted away from the roofliner into the non-usage setting and/or toward the non-usage setting in the direction toward the roofliner, and/or
(ii) is only moved out of a region behind a seat row into a region in front of the seat row when a seat or seats of the seat row is or are located in a collision-avoiding setting, position, orientation, and/or in a relaxation setting.

15. The display device according to claim 14, further comprising:
a sensor unit or a first operational connection to a sensor unit, wherein the sensor unit is configured to acquire a current position and/or alignment of a respective seat row, one or more parts thereof, and/or an occupant, and to transmit a signal representative thereof to the control unit, and
the control unit is configured to control in a closed-loop manner the movement unit and therefore a position, orientation, and/or usage setting of the display unit and/or a display element thereof as a function of the representative signal.

16. The display device according to claim 15, further comprising:
a second operational connection to a further control unit of a seat row,
the control unit being configured to control in a closed-loop manner the movement unit and therefore a position, orientation, and/or usage setting of the display unit and/or a display element thereof as a function of control data of the further control unit for setting the seat row.

17. The display device according to claim 11, wherein
the display unit is formed with a rectangular form, and wherein:
in the state of the display device installed on the associated vehicle, transverse edges are aligned in parallel to a transverse extension direction of the vehicle, and/or
in the state of the display device installed on the associated vehicle, longitudinal edges are aligned in parallel to the longitudinal extension direction of the associated vehicle.

18. The display device according to claim 11, further comprising:
a drive unit configured to drive the movement unit and/or which is controllable in a closed-loop and/or open-loop manner via a control unit.

19. A vehicle, comprising:
a vehicle body;
an interior formed by the vehicle body and having a roofliner; and
a display device according to claim 11 attached on or in the roofliner.

20. A method of operating a display device for an interior of a vehicle, wherein
the display device includes a display unit for visual display of information, which is arranged on a roofliner of the vehicle, comprising:
moving the display unit in a manner that is controllable in a closed-loop and/or open-loop manner, via a movement unit, along a longitudinal extension direction between various usage settings, and/or holding the display unit in a given usage setting; and
controlling a movement of the display unit in a closed-loop and/or open-loop manner, via a control unit, in such a way that a first usage setting has a first position for a or in a front seat row in the longitudinal extension direction and a second usage setting has a second position for or in a rear seat row the longitudinal extension direction or for a or in a luggage compartment for the display unit.
